(19) United States
(12) Patent Application Publication
(10) Pub. No.: US 2012/0123983 A1
(43) Pub. Date: May 17, 2012

(54) AUTOMATIC SYSTEMS AND METHODOLOGIES FOR EARTHQUAKE PREDICTION AND WARNING

(75) Inventors: Akiva FLEXER, Ramat Hasharon (IL); Annat YELLIN-DROR, Herzeliya (IL)

(73) Assignee: TECTOSENSE LTD., Tel-Aviv (IL)

(21) Appl. No.: 12/946,374

(22) Filed: Nov. 15, 2010

(51) Int. Cl. G01V 1/28; G06N 3/02; G06F 19/00

(52) U.S. Cl. 706/21; 702/15; 706/15

(57) ABSTRACT

A system for predicting earthquakes including first sensing functionality for sensing at least one earthquake prediction parameter at least a first point in time prior to an expected earthquake event, second sensing functionality for sensing at least one earthquake prediction parameter at least a second point in time prior to the expected earthquake event, the second point in time being different from the first point in time, and prediction functionality operative in response to outputs from the first sensing functionality and from the second sensing functionality to provide a prediction of an expected earthquake event.

### FIELD OF THE INVENTION

The present invention relates to earthquake prediction and more particularly to automatic systems and methodologies for earthquake prediction and warning.

### BACKGROUND OF THE INVENTION

The following publications are believed to represent the current state of the art and are hereby incorporated by reference:
U.S. Pat. Nos. 5,396,223; 5,783,945; 5,694,129; 5,811,974; 6,356,204; 6,622,093 and 7,277,797;
U.S. Published Patent Application Nos.: 2004/0075552; 2004/0098198; 2004/0135698; 2006/0042177; 2006/0081412; 2006/0193207; 2007/0233390; 2007/0199382 and 2007/0279239;
PCT Published Application Nos.: WO 1996/027865; WO 2005/006022; WO 2007/143799; WO 2008/093515; WO 2008/143588 and WO 2009/016595;
Russia Published Application Nos.: RU2204852; RU2239852; RU2255356; RU2329525;
Japan Patent Nos.: JP2206731; JP6138244; JP8271315; JP8285954; JP9080163; JP9178864; JP10142041; JP10186047; JP10311881; JP2000162032; JP2001174321; JP2001183467; JP2001349772; JP2002311043; JP2003215259; JP2004077448; JP2005301542; JP2005337923; JP2006023982; JP2006138769; JP2006292449; JP2007298446; JP2008164353; JP2008180609 and JP2008242904;
China Patent Nos.: CN101329808; CN101329809; CN101339253; CN201035153; CN201045669 and CN201196824;
Mexico Patent No.: MX9704119;
Ukranian Republic Patent No.: UA75031;
Greece Patent No.: GR1003024;

Forecasting Techniques developed and published by QuakeFinder at http://www.quakefinder.com/research/forecasttech.php;
Quake Alarm Earthquake Detector at http://www.quakealarm.com;
QuakeSat Mission at http://www.quakefinder.com/services/quakesat-ssite;
Arabelos, D., Asteriadis, G., Contadakis, M., Zioutas, G., Daoyi, Xu., Cunde Zhang and Binghua Zheng, 2001. The use of an outlier detecting method in time series of continuous daily measurements of underground water level and temperature in earthquake prediction investigation; Tectonophysics, 2001, 338: 315-323;
Bleier, T., Dunson, C/, Mauiscalco, M., Bryant, N., Bambery, R. and Freund, F., 2009. Investigation of ULF magnetic pulsations, air conductivity changes and infra red signature associated with the 30 October Alum Rock M5.4 earthquake. Nat. Hazards Earth Syst. Sci., 9: 585-603;
Bungum, H., Lindholm, C. D. and Dahle, A., 2003. Long-period ground-motions for large European earthquakes, 1905-1992, and comparisons with stochastic predictions. Journal of Seismology, 7; 377-396;
Carayannis, G. P., 2009. Earthquake prediction in China, Monitoring Animal Behavior. Excerpts from Unpublished Manuscript;
Cicerone, D., Ebel J. E. and Britton, J., 2009. A systematic compilation of earthquake precursors. Tectonophysics, 476: 371-396;
Hayakawa, M., Molchanov, 0. A. and NASDA/UEC team, 2004. Achievements of NASDA's earthquake remote sensing frontier project. TAO, 15: 311-327;
Hayakawa, M., Hattori, K/and Ohta, K., 2007. Monitoring of ULF (ultra low frequency) geomagnetic variation associated with earthqukes. Sensors, 7: 1108-1122;
Hobara, Y., Koons, H. C., Roeder, J. L., Yumoto L. K. and Hayakawa, M. 2004. Characteristics of ULF magnetic anomaly before earthquakes. Phys. and Chem. of the Earth, 29: 437-444;
Ikeya, M., Yamanaka, C., Mattsuda, T., Sasaoka, H., Ochiai, H., Huang, Q., Ohtani, N., Komuranani, T., Ohta, M., Ohno, Y. and Nakagawa, T., 2000. Electromagnetic pulses generated by compression of granitic rocks and animal behavior. Episodes 23(4): 262-265;
Johnson, H., Saleur, D. and Sornette, D., 2000. New evidence of earthquake precursory phenomena in the 17 Jan. 1995 Kobe earthquake. Japan. Eur. Phys. J. Bull. 15: 551-555;
Karakelian, D., Klemperer, S. L. and Fraser-Smith A. C., 2000. A transportable system for monitoring Ultra Low Frequency Electromagnetic Signals Associated with earthquakes. Seismological Res. Lett., 71: 423-436;
Khalilov, E. N., 2007. About possibility of creation of international global system of forecasting the earthquakes “Atropatena” (Baku-Yogyakarta-Islamabad). National Cataclysms and Global Problems of the Modern Civilization, Special edition Transaction of the International Academy of Science. H&E. ICSD/IAS. Baku-Innsbruck, 51-69;
Khalilov, E. N., 2008. Forecasting of earthquakes: the reason of failures and the new philosophy. Science Without Borders. Transaction of the International Academy of Science H&E. 3: 300-315;
Khalilov, E. N., 2009. Global network of forecasting the earthquakes: new technology and new philosophy. London, SWB, 65 p;
King, C. Y., Azuma, S., Ohno, M., Asai, Y., He, P., Kitagawa, Y., Igarashi, G. and Wakita, H., 2000. In search of earthquake precursors in the water-level data of 16 closely clustered wells at Tono, Japan. Geophys. J. Int., 143: 469-477;
Kirschvink, J. L., 2000. Earthquake prediction by animals: Evolution and sensory perception. Bull. Seismological Society of America, 90: 312-323;
Lighton, J. R. B. and Ducan, F. D., 2005. Shaken, not stirred: a serendipitous study of ants and earthquakes. The Journal of Experimental Biology, 208: 3103-3107;
Matsumoto, N. and Roeloffs, E. A., 2003. Hydrogeological response to earthquakes in the Haibara well, central Japan—II. Possible mechanism inferred from time-varying hydrologic properties. Geophys. J. Int., 155: 899-913;
Mucciarelli, M. and Albarello, D., 1991. The use of historical data in earthquake prediction: an example from water-level variations and seismicity. Tectonophysics, 193: 247-251;
Nur, A., 1990. Comment on “Shear wave anisotropy of active tectonic regions via automated S-wave polarization analysis” by M. K. Savage, X. R. Shih, R. P. Meyer and R. C. Aster, and “Azimuthal variations in P-wave travel times and shear-wave splitting in the Charlevoix seismic zone” by G. G. R. Buchbinder. Tectonophysics, 172: 195-196;
Pizzino, L., Burrato, P., Quattrocchi, F. ad Valensise, G., 2004. Geochemical signatures of large active faults: The example of the 5 Feb. 1783, Calabrian earthquake (southern Italy). Journal of Seismology, 8: 363-380;
Pulinets, S. A., 1998. Strong earthquake prediction possibility with the help of topside sounding from satellites. Adv. Space Res., 21: 455-458;
Rouland, D., Legrand, D., Zhizhin, M. and Vergniolle, S., 2009. Automatic detection and discrimination of volcanic tremors and tectonic earthquakes: An application to Ambrym volcano, Vanuatu. Journal of Volcanology and Geothermal Research, 2009, 181: 196-206;
Schaal, R. B., 1988. An evolution of the animal-behavior theory for earthquake prediction. California Geology, 41. No. 2: 1-9;
Scordilis, E. M., Papazachos, C. B., Karakaisis, G. F. and Karakostas, V. G., 2004. Accelerating seismic crustal deformation before strong main shocks in Adriatic and its importance for earthquake prediction, Journal of Seismology, 8: 57-70;
Tasukuda, T., 2008. Radon-gas monitoring by gamma-ray measurements on the ground for detecting crustal activity changes—preliminary study by repeat survey methods, Bull. Earthq. Res. Inst. Univ. Tokyo, 88: 227-241; and
Wang, R., Woith, H., Milkereit, C. and Zschau, J., 2004. Modeling of hydrgeochemical anomalies induced by distant earthquakes. Geophys. J. Int., 157: 717-726.

### SUMMARY OF THE INVENTION

The present invention seeks to provide automatic earthquake prediction and warning systems and functionalities which provide useful prediction information, both in terms of warning time and in terms of false alarm immunity.

There is thus provided in accordance with a preferred embodiment of the present invention a system for predicting earthquakes including first sensing functionality for sensing at least one earthquake prediction parameter at least a first point in time prior to an expected earthquake event, second sensing functionality for sensing at least one earthquake prediction parameter at least a second point in time prior to the expected earthquake event, the second point in time being different from the first point in time, and prediction functionality operative in response to outputs from the first sensing functionality and from the second sensing functionality to provide a prediction of an expected earthquake event.

In accordance with a preferred embodiment of the present invention, the system also includes third sensing functionality for sensing at least one earthquake prediction parameter at least a third point in time prior to the expected earthquake event, the third point in time being different from the first point in time and the second point in time and wherein the prediction functionality is operative in response to outputs from the first sensing functionality, the second sensing functionality and the third sensing functionality to provide a prediction of an expected earthquake event.

Preferably, each of the first, second and third sensing functionalities is operative to provide data outputs of the sensing to at least one data logger. Additionally, the at least one data logger provides data logger outputs to the system, the data logger outputs including periodic sensor values and respective associated time stamps, wherein the periodic sensor values differ from a steady state value by a predetermined deviation.

Preferably, the system is operative to correlate data from the at least one data logger of each of the first, second and third sensing functionalities. Additionally, the system is operative to store the data logger outputs. Additionally, the system is operative to receive and store seismic data regarding actual earthquake events, the seismic data including at least one of a magnitude on the Richter scale and a time stamp.

In accordance with a preferred embodiment of the present invention, the prediction functionality is operative in response to outputs from the first sensing functionality, from the second sensing functionality and from the third sensing functionality to match a combination of the outputs with learned earthquake event prediction patterns to provide a prediction of an expected earthquake event. Preferably, the learned earthquake event prediction patterns tie historical combinations of outputs from the first sensing functionality, from the second sensing functionality and from the third sensing functionality to historical earthquake events. Preferably, the prediction functionality employs an artificial neural network.

Preferably, the prediction includes a prediction of a future time to an expected earthquake event and a level of certainty associated therewith, and a prediction of an expected magnitude of the expected earthquake event and a level of certainty associated therewith. Additionally, the prediction functionality is operative to provide a report of the prediction to predetermined recipients.

There is also provided in accordance with another preferred embodiment of the present invention a system for predicting earthquakes including first sensing functionality for sensing at least a first earthquake prediction parameter being in a first of physical, biological and hydrological parameter categories prior to an expected earthquake event, second sensing functionality for sensing at least a second earthquake prediction parameter being in one of the physical biological and hydrological categories different from the first category prior to the expected earthquake event, and prediction functionality operative in response to outputs from the first sensing functionality and from the second sensing functionality to provide a prediction of an expected earthquake event.

In accordance with a preferred embodiment of the present invention, the system also includes third sensing functionality for sensing at least a third earthquake prediction parameter being in one of the physical, biological and hydrological categories different from the first category and the second category, prior to the expected earthquake event and wherein the prediction functionality is operative in response to outputs from the first sensing functionality, from the second sensing functionality and from the third sensing functionality to provide a prediction of an expected earthquake event.

Preferably, each of the first, second and third sensing functionalities is operative to provide data outputs of the sensing to at least one data logger. Additionally, the at least one data logger provides data logger outputs to the system, the data logger outputs including periodic sensor values and respective associated time stamps, wherein the periodic sensor values differ from a steady state value by a predetermined deviation. Preferably, the system is operative to correlate data from the at least one data logger of each of the first, second and third sensing functionalities. Additionally, the system is operative to store the data logger outputs. Additionally, the system is operative to receive and store seismic data regarding actual earthquake events, the seismic data including at least one of a magnitude on the Richter scale and a time stamp.

In accordance with a preferred embodiment of the present invention, the physical category includes ULF related parameters. Additionally, the hydrological category includes parameters relating to levels of salinity, temperature, water, water turbidity, ion concentration, and the presence of nitrates, sulfates, radon and other gases. Additionally, the biological category includes parameters relating to levels of animal activity. Preferably, the levels of animal activity are sensed by at least one of at least one camera and at least one computer including suitable software.

Preferably, the prediction functionality is operative in response to outputs from the first sensing functionality, from the second sensing functionality and from the third sensing functionality to match a combination of the outputs with learned earthquake event prediction patterns to provide a prediction of an expected earthquake event. Additionally, the learned earthquake event prediction patterns tie historical combinations of outputs from the first sensing functionality, from the second sensing functionality and from the third sensing functionality to historical earthquake events. Preferably, the prediction functionality employs an artificial neural network.

In accordance with a preferred embodiment of the present invention, the prediction includes a prediction of a future time to an expected earthquake event and a level of certainty associated therewith, and a prediction of an expected magnitude of the expected earthquake event and a level of certainty associated therewith. Preferably, the prediction functionality is operative to provide a report of the prediction to predetermined recipients.

There is further provided in accordance with yet another preferred embodiment of the present invention a system for predicting earthquakes including first sensing functionality for sensing at least a first earthquake prediction parameter at least a first point in time prior to an expected earthquake event, the first earthquake prediction parameter being in a first of physical, biological and hydrological parameter categories, second sensing functionality for sensing at least a second earthquake prediction parameter at least a second point in time prior to the expected earthquake event, the second point in time being different from the first point in time, the second earthquake prediction parameter being in one of the physical biological and hydrological categories different from the first category, and prediction functionality operative in response to outputs from the first sensing functionality and from the second sensing functionality to provide a prediction of an expected earthquake event.

In accordance with a preferred embodiment of the present invention, the system also includes third sensing functionality for sensing at least a third earthquake prediction parameter at least a third point in time prior to the expected earthquake event, the third point in time being different from the first point in time and the second point in time, the third earthquake prediction parameter being in one of the physical, biological and hydrological categories different from the first category and the second category and wherein the prediction functionality is operative in response to outputs from the first sensing functionality, the second sensing functionality and the third sensing functionality to provide a prediction of an expected earthquake event.

Preferably, each of the first, second and third sensing functionalities is operative to provide data outputs of the sensing to at least one data logger. Additionally, the at least one data logger provides data logger outputs to the system, the data logger outputs including periodic sensor values and respective associated time stamps, wherein the periodic sensor values differ from a steady state value by a predetermined deviation. Additionally, the system is operative to correlate data from the at least one data logger of each of the first, second and third sensing functionalities.

Preferably, the system is operative to store the data logger outputs. Additionally, the system is operative to receive and store seismic data regarding actual earthquake events, the seismic data including at least one of a magnitude on the Richter scale and a time stamp.

In accordance with a preferred embodiment of the present invention, the physical category includes ULF related parameters. Additionally, the hydrological category includes parameters relating to levels of salinity, temperature, water, water turbidity, ion concentration, and the presence of nitrates, sulfates, radon and other gases. Additionally, the biological category includes parameters relating to levels of animal activity. Preferably, the levels of animal activity are sensed by at least one of at least one camera and at least one computer including suitable software.

In accordance with a preferred embodiment of the present invention, the prediction functionality is operative in response to outputs from the first sensing functionality, from the second sensing functionality and from the third sensing functionality to match a combination of the outputs with learned earthquake event prediction patterns to provide a prediction of an expected earthquake event.

Preferably, the learned earthquake event prediction patterns tie historical combinations of outputs from the first sensing functionality, from the second sensing functionality and from the third sensing functionality to historical earthquake events. Preferably, the prediction functionality employs an artificial neural network. Preferably, the prediction includes a prediction of a future time to an expected earthquake event and a level of certainty associated therewith, and a prediction of an expected magnitude of the expected earthquake event and a level of certainty associated therewith. Preferably, the prediction functionality is operative to provide a report of the prediction to predetermined recipients.

There is yet further provided in accordance with still another preferred embodiment of the present invention a method for predicting earthquakes including sensing at least a first earthquake prediction parameter at least a first point in time prior to an expected earthquake event, sensing at least a second earthquake prediction parameter at least a second point in time prior to the expected earthquake event, the second point in time being different from the first point in time, and in response to outputs from the sensing a first earthquake prediction parameter and from the sensing a second earthquake prediction parameter, providing a prediction of an expected earthquake event.

In accordance with a preferred embodiment of the present invention, the method also includes sensing at least a third earthquake prediction parameter at least a third point in time prior to the expected earthquake event, the third point in time being different from the first point in time and the second point in time, and in response to outputs from the sensing a first earthquake prediction parameter, from the sensing a second earthquake prediction parameter and from the sensing a third earthquake prediction parameter, providing a prediction of an expected earthquake event.

There is also provided in accordance with another preferred embodiment of the present invention a method for predicting earthquakes including sensing at least a first earthquake prediction parameter being in a first of physical, biological and hydrological parameter categories prior to an expected earthquake event, sensing at least a second earthquake prediction parameter being in one of the physical biological and hydrological categories different from the first category prior to the expected earthquake event, and in response to outputs from the sensing a first earthquake prediction parameter and from the sensing a second earthquake prediction parameter, providing a prediction of an expected earthquake event.

In accordance with a preferred embodiment of the present invention, the method also includes sensing at least a third earthquake prediction parameter being in one of the physical, biological and hydrological categories different from the first category and the second category, prior to the expected earthquake event and wherein in response to outputs from the sensing a first earthquake prediction parameter, from the sensing a second earthquake prediction parameter and from the sensing a third earthquake prediction parameter, providing a prediction of an expected earthquake event.

There is further provided in accordance with yet another preferred embodiment of the present invention a method for predicting earthquakes including sensing at least a first earthquake prediction parameter at least a first point in time prior to an expected earthquake event, the first earthquake prediction parameter being in a first of physical, biological and hydrological parameter categories, sensing at least a second earthquake prediction parameter at least a second point in time prior to the expected earthquake event, the second point in time being different from the first point in time, the second earthquake prediction parameter being in one of the physical biological and hydrological categories different from the first category, and in response to outputs from the sensing a first earthquake prediction parameter and from the sensing a second earthquake prediction parameter, providing a prediction of an expected earthquake event.

In accordance with a preferred embodiment of the present invention, the method also includes sensing at least a third earthquake prediction parameter at least a third point in time prior to the expected earthquake event, the third point in time being different from the first point in time and the second point in time, the third earthquake prediction parameter being in one of the physical, biological and hydrological categories different from the first category and the second category and wherein in response to outputs from the sensing a first earthquake prediction parameter, from the sensing a second earthquake prediction parameter and from the sensing a third earthquake prediction parameter, providing a prediction of an expected earthquake event.

### BRIEF DESCRIPTION OF THE DRAWINGS

The present invention will be understood and appreciated more fully from the following detailed description, taken in conjunction with the drawings in which:

FIGS. 1A, 1B, 1C and 1D are simplified pictorial illustrations of the operation of an automatic earthquake prediction and warning system constructed and operative in accordance with a preferred embodiment of the present invention;

FIG. 2 is a simplified block diagram illustration of a preferred embodiment of the system of FIGS. 1A-1D; and

FIGS. 3A and 3B are together a simplified flow chart illustrating operation of the system of FIGS. 1A-2 in accordance with a preferred embodiment of the present invention.

### DETAILED DESCRIPTION OF PREFERRED EMBODIMENT

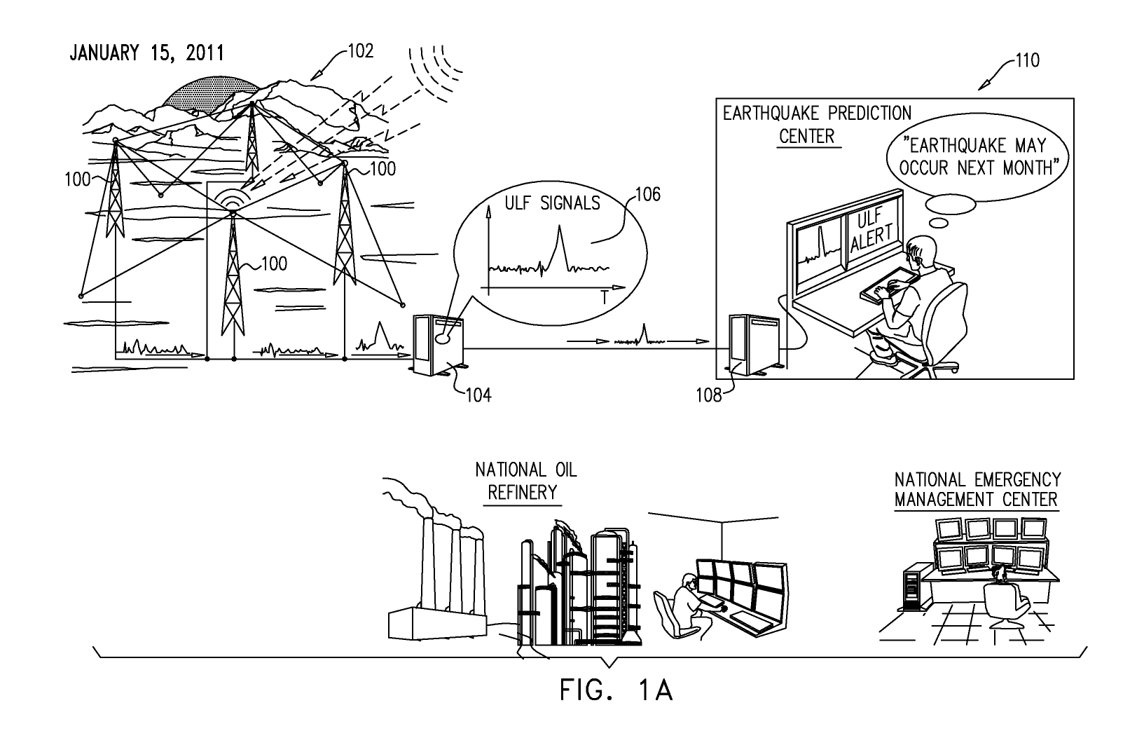

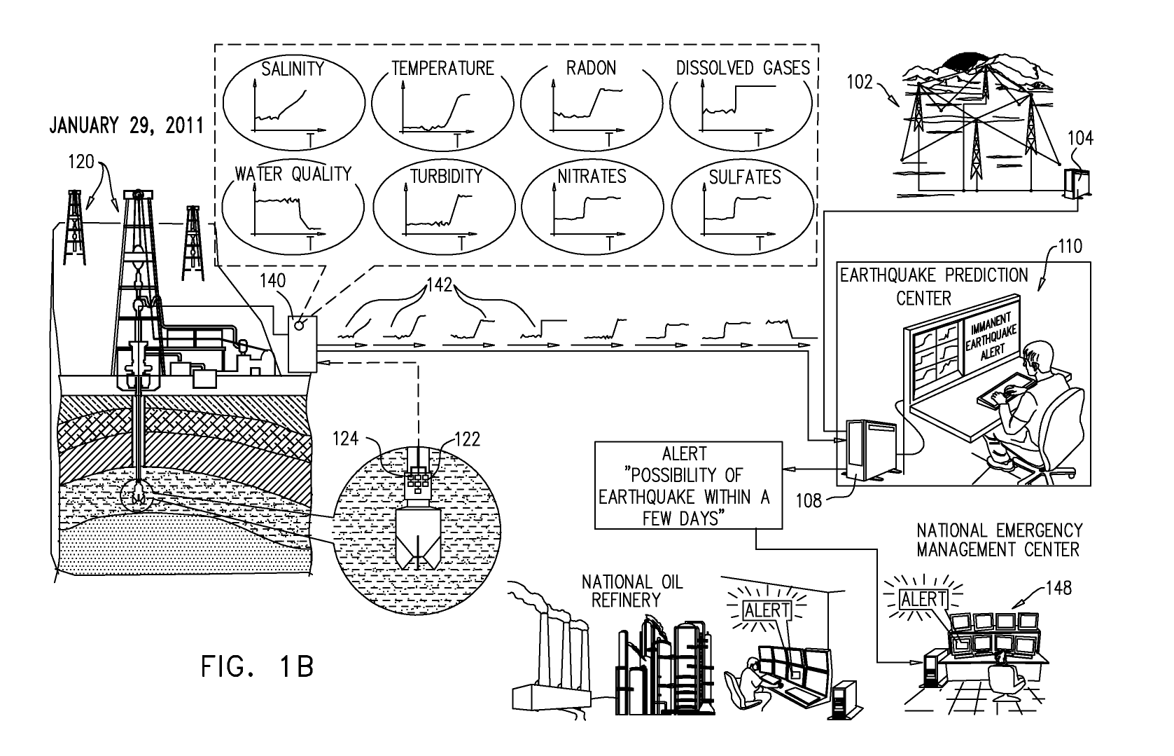

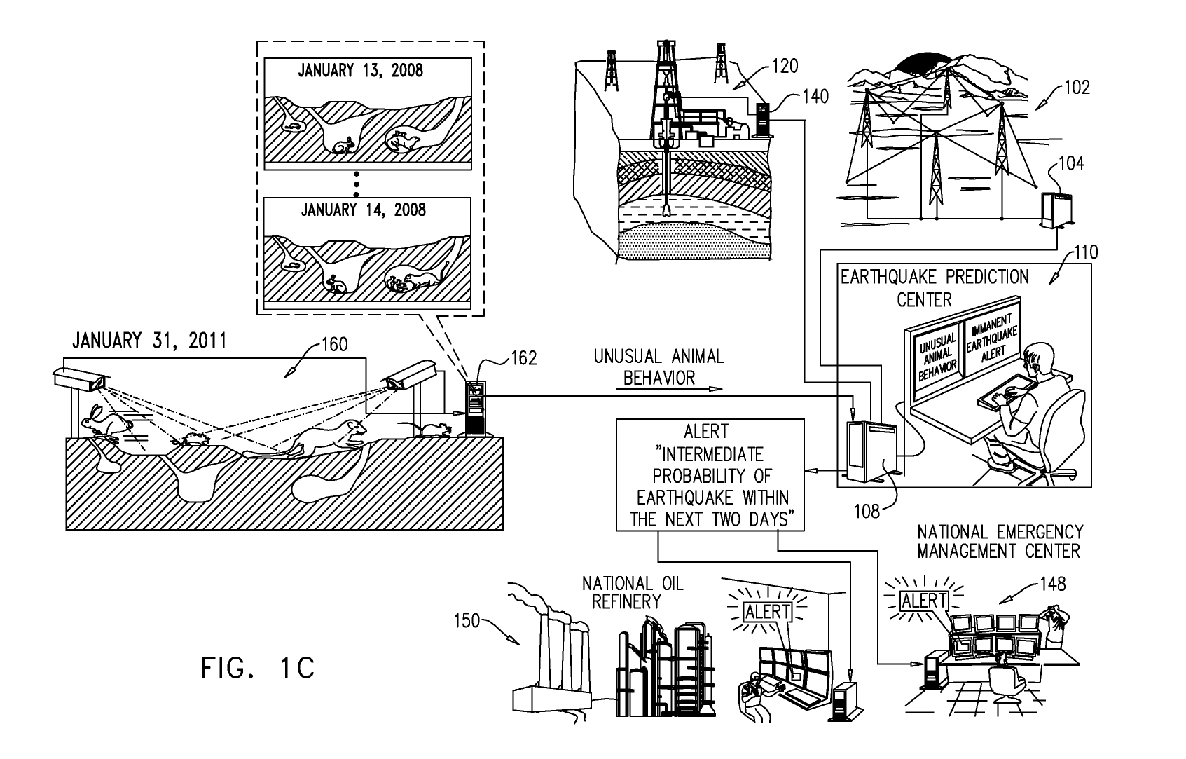

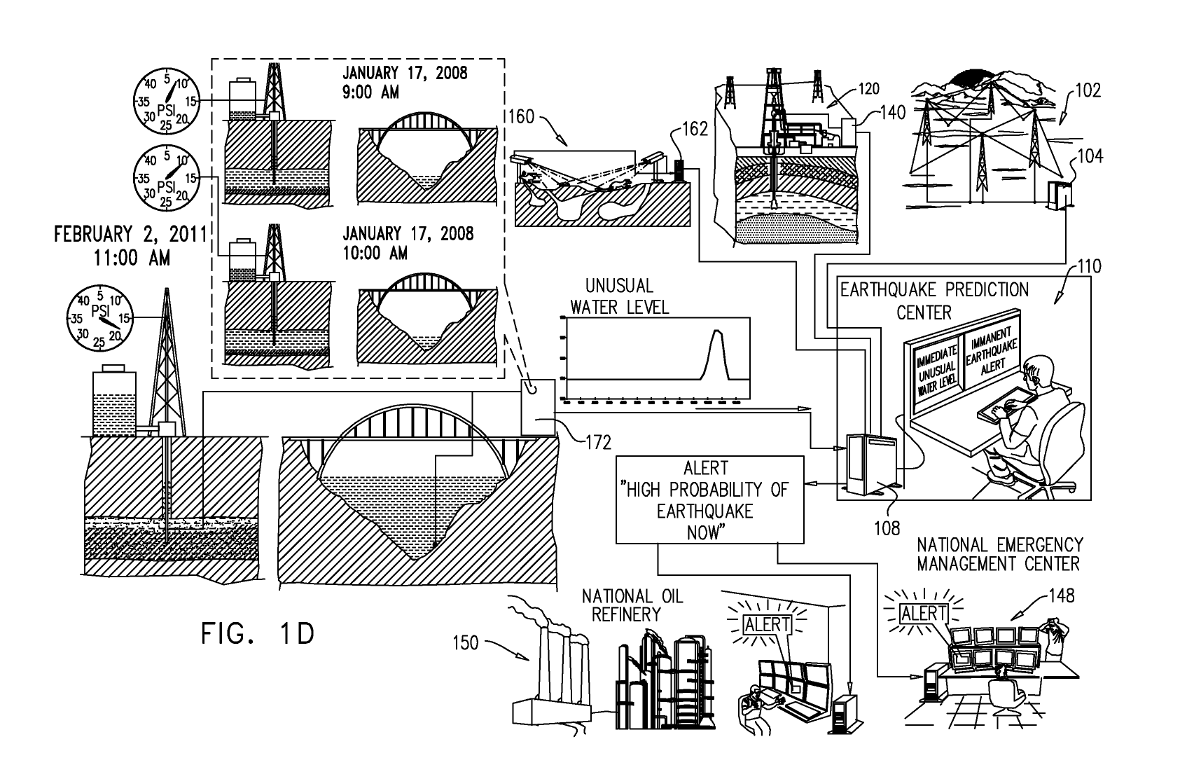

Reference is now made to FIGS. 1A, 1B, 1C and 1D, which are simplified pictorial illustrations of the operation of an automatic earthquake prediction and warning system constructed and operative in accordance with a preferred embodiment of the present invention.

As seen in FIGS. 1A-1D, there is provided a system for predicting earthquakes including first sensing functionality for sensing an earthquake prediction parameter at least a first point in time prior to an expected earthquake event, second sensing functionality for sensing an earthquake prediction parameter at least a second point in time prior to the expected earthquake event, the second point in time being different from the first point in time, and prediction functionality operative in response to outputs from the first sensing functionality and from the second sensing functionality for providing a prediction of an expected earthquake event.

In the system of FIGS. 1A-1D, and as seen particularly in FIG. 1A, the first sensing functionality is preferably ULF sensing functionality. ULF (Ultra Low Frequency, typically in the range of 0.01-3 Hz) signals are received from the atmosphere, preferably by sensors 100, forming part of a dedicated ULF sensor farm 102. Sensors 100 are preferably LEMI-030 Induction Magnetometers manufactured by Laboratory of Electromagnetic Innovations of Lviv, Ukraine, and are coupled to a computer 104 which preferably provides a filtered ULF signal output 106. A strong peak in the filtered ULF signal output 106 provides a preliminary indication of an expected earthquake event, typically about two to four weeks before the expected earthquake event.

Published descriptions of some ULF signal sensing functionality include the following and are hereby incorporated by reference:

Forecasting Techniques developed and published by QuakeFinder (http://www.quakefinder.com/research/forecasttech.php); and

QuakeSat—a satellite for collecting ULF earthquake precursor signals from space (http://www.quakefinder.com/services/spaceproducts.php).

The filtered ULF signal output 106 is preferably received by a computer 108 at an earthquake prediction center 110.

Turning now to FIG. 1B, it is seen that additional sensing functionalities, which sense various parameters of an aquifer, are provided. These parameters preferably include salinity, temperature, water level, turbidity, ion concentration, and the presence of nitrates, sulfates, radon and other gases. Salinity, temperature and water level are sensed preferably by DIVER® sensors 122, commercially available from Schlumberger Ltd., of Houston, Tex. Turbidity is sensed preferably by a 6136 Turbidity Sensor (6-Series) 124, commercially available from YSI Inc., of Yellow Springs, Ohio. Ion concentration and the presence of nitrates, sulfates, radon and other gases are sensed preferably by a Westbay Multilevel Groundwater Monitoring System 126, commercially available from Schlumberger Ltd., of Houston, Tex. The aforementioned sensors are preferably located at a well 120.

Sudden changes in one or more of salinity, temperature, turbidity, ion concentration, and the presence gases are known to provide an indication of an expected earthquake event typically between 7 days and 2 days prior to the event. Sudden changes in water level are known to provide an indication of an expected earthquake event typically between 5 hours and 30 minutes prior to the event.

Outputs of sensors 122, 124 and 126 are preferably supplied to a data logger 140, such as an R-LOG, commercially available from Remmon Remote Monitoring Ltd. of Bet She'an, Israel. Data logger 140 filters and combines the outputs as appropriate. Data logger 140 preferably provides a plurality of signal outputs 142 to earthquake prediction center 110. Preferably, multiple data loggers 140 each provide outputs from a different well to the earthquake prediction center 110. Typically over one hundred data loggers 140 provide outputs to the earthquake prediction center 110, enabling the earthquake prediction center 110 to correlate data from a large number of wells 120.

Preferably upon receipt of an indication of sudden changes in one or more of the above parameters in multiple wells 120, particularly when combined with an earlier received strong peak in the filtered ULF signal output 106, the earthquake prediction center 110 provides, preferably automatically via server 108, an alert indicating a possibility of an earthquake within a few days. This alert is preferably sent to a responsible government entity 148.

Turning now to FIG. 1C, it is seen that further sensing functionalities, which sense unusual animal behavior are provided. Sensors, such as video cameras 160 which observe animal behavior in a controlled environment, preferably provide outputs to a computer 162 which stores behavior data. Computer 162 provides an unusual animal behavior output to the earthquake prediction center 110 when it senses a significantly different pattern of animal activity than is usual. Unusual animal behavior sensing and reporting subsystems, including cameras 160 and a computer 162 with suitable software, which are useful for this purpose, are commercially available from Viewpoint Life Sciences Inc., of Lyon, France.

Preferably upon receipt of an indication of sudden changes in animal behavior, particularly when combined with earlier received indications of sudden changes in one or more of the above-indicated parameters in multiple wells 120 and an even earlier received strong peak in the filtered ULF signal output 106, the earthquake prediction center 110 provides, preferably automatically via server 108, an alert indicating an intermediate probability of an earthquake within a day or two. This alert is preferably sent to the responsible government entity 148 as well as operation centers of critical industries, which could suffer catastrophic consequences from an earthquake absent warning of at least a few days, such as oil refinery 150.

Turning now to FIG. 1D, it is seen that still further sensing functionalities, which sense sudden changes in water levels in wells or reservoirs and/or sudden changes in water well output rates are provided. Sensors 170, such as DIVER® sensors from Schlumberger Ltd., of Houston, Tex., which observe water levels, and rate sensors which sense well output rates are provided. Sensors 170 preferably provide outputs to one or more data loggers 172, such as an R-LOG, commercially available from Remmon Remote Monitoring Ltd. of Bet She'an, Israel, which store and transmit such data to the earthquake prediction center 110, where server 108 senses significant changes in water level and/or pumping rates.

Preferably, multiple data loggers 172 each provide outputs from a different well or reservoir to the earthquake prediction center 110. Typically over one hundred data loggers 172 provide outputs to the earthquake prediction center 110, enabling the earthquake prediction center 110 to correlate data from such sources.

Preferably upon receipt of an indication of sudden changes in water levels or pumping rates, particularly when combined with earlier received indications of changes in animal behavior, even earlier received indications of sudden changes in one or more of the above-indicated parameters in multiple wells 120 and an even earlier received strong peak in the filtered ULF signal output 106, the earthquake prediction center 110 provides, preferably automatically via server 108, an alert indicating a high probability of an earthquake within a few hours. This alert is preferably sent to the responsible government entity 148 as well as operation centers of critical industries, such as oil refinery 150.

It is appreciated that normally, the earthquake prediction center 110 continually receives inputs from all of the various sensing functionalities at all times.

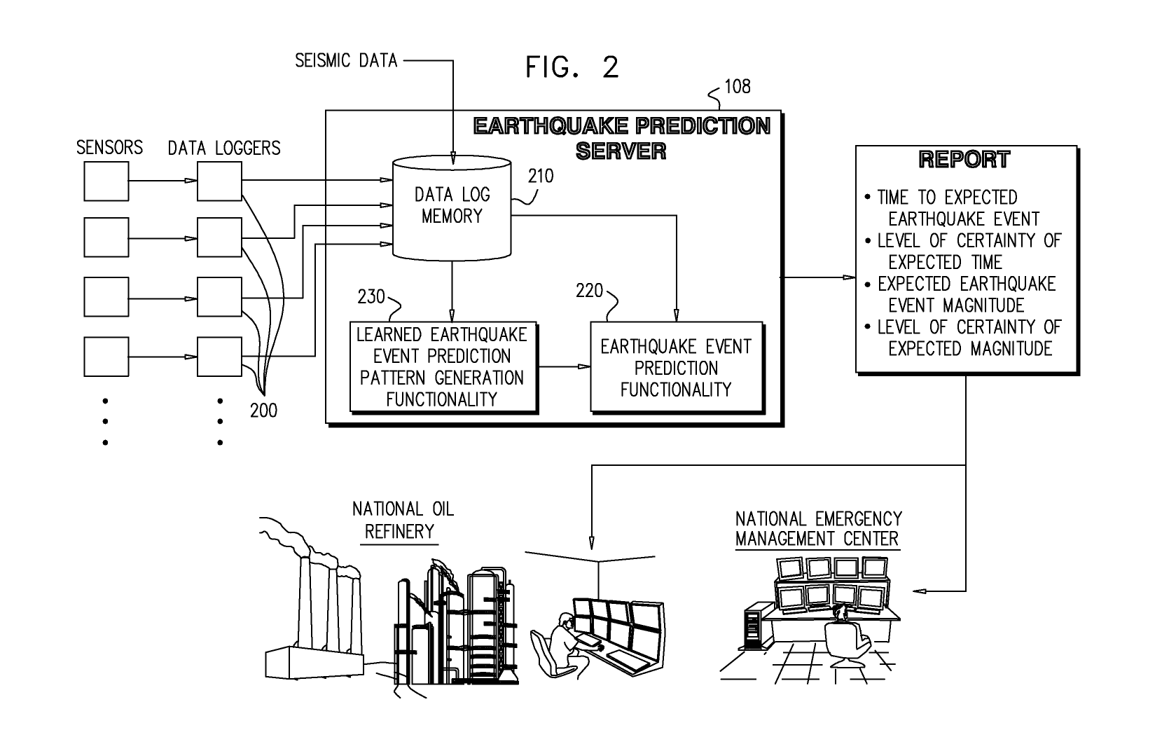

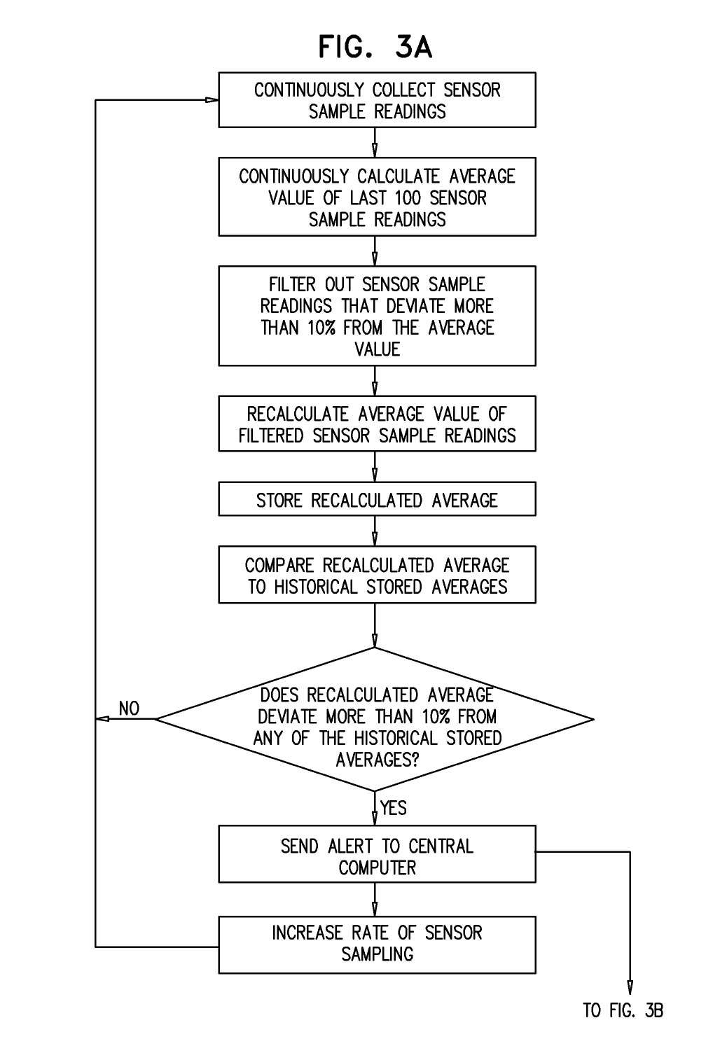

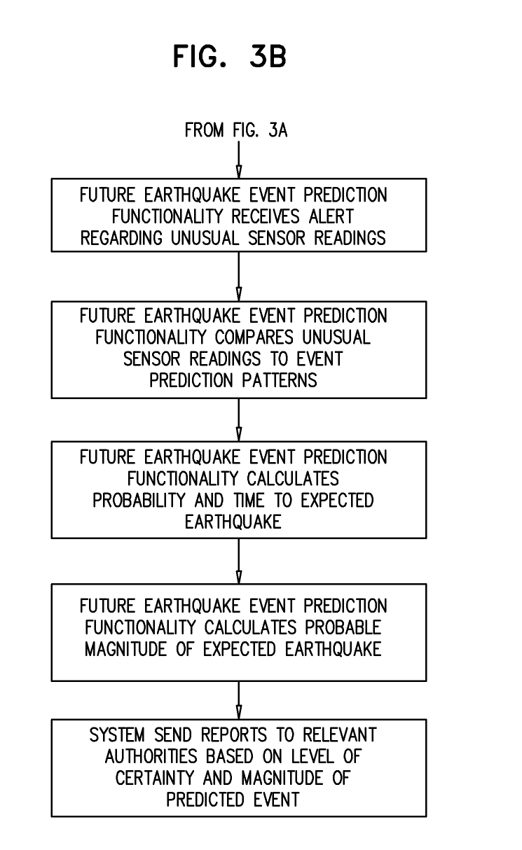

Reference is now made to FIG. 2, which is a simplified block diagram illustration of a preferred embodiment of the system of FIGS. 1A-1D, and to FIGS. 3A-3B, which together describe one example of operation of the system of FIG. 2.

As seen in FIG. 2, inputs from each of sensors 200 are preferably supplied to server 108 (FIGS. 1A-1D) via separate data loggers 202, such as computer 104 in FIG. 1A, data logger 140 in FIG. 1B, computer 162 in FIG. 1C and data loggers 172 in FIG. 1D. Outputs of data loggers 202 preferably include periodic sensor value reports each including a value and a time stamp, as well as sensor event reports, which are responsive to sensed event inputs which differ from a steady state value by a predetermined deviation.

Server 108 preferably comprises a multi-input data log memory 210 which stores the values and time stamps received from each data logger 202, and also receives and stores seismic data regarding earthquakes which is readily available. Such seismic data preferably includes a value, such as a magnitude on the Richter scale and a time stamp. Server 108 preferably also includes future earthquake event prediction functionality 220. Functionality 220 is responsive to reports of sensed event inputs received from the data loggers 202 and provides earthquake event predictions, based on matching of a combination of sensed event inputs, and learned earthquake event prediction patterns which tie various stored historical combinations of sensed event inputs to stored historical earthquake events.

The learned prediction patterns are preferably provided by learned earthquake event prediction pattern generation functionality 230 which receives inputs from the multi-input data memory 210 and which provides continually updated learned earthquake event prediction patterns. Learned earthquake event prediction pattern generation functionality 230 preferably employs an artificial neural network or other suitable association technique for providing prediction patterns which match a multiplicity of different combinations of sensed events of differing value and time relationships from a multiplicity of different sensors, such that for practically every possible combination of sensed events, there exists an updated learned earthquake event prediction pattern.

A few examples of possible learned earthquake event prediction patterns appear in Tables I-1, I-2 and I-3 below:

TABLE I-1

| | EVENT INPUT/ | |
|---|---|---|
| | EARTHQUAKE | |
| DATE & TIME | EVENT | EVENT DETAILS |
| Mar. 15, 2009 | ULF peak | 0.1 nanoTesla->5 nanoTesla |
| 14:16 | | (depending on the distance from |
| | | the epicenter) |
| Mar. 29, 2009 | Rise of temperature | A few degrees Celsius |
| 06:32 | | |
| Mar. 29, 2009 | Chemical changes in | In excess of 10 parts per million |
| 15:31 | water quality | (Na+, Ca++, Mg++, SO₄−−, |
| | | HCO₃−, F−, Cl−) |
| Mar. 31, 2009 | Change in animal | Significant |
| 18:32 | activity | |
| Apr. 2, 2009 | Change in pumping | In excess of 10 m³/sec |
| 00:58 | rates in water | |
| | wells in defined | |
| | localities | |
| Apr. 2, 2009 | Changes of water | Several meters |
| 04:21 | levels in defined | |
| | localities | |

OUTCOME—AN EARTHQUAKE OF A MAGNITUDE IN EXCESS OF 6 ON THE RICHTER SCALE OCCURRED ON APR. 2, 2009 AT 05:11.

TABLE I-2

| | EVENT INPUT/ | |
|---|---|---|
| | EARTHQUAKE | |
| DATE & TIME | EVENT | EVENT DETAILS |
| Mar. 15, 2009 | ULF peak | 0.1 nanoTesla->5 nanoTesla |
| 14:16 | | (depending on the distance from |
| | | the epicenter) |
| Mar. 29, 2009 | Rise of temperature | Slight |
| 06:32 | | |
| Mar. 29, 2009 | Chemical changes in | Slight (Cl−) |
| 15:31 | water quality | |
| | Change in animal | None |
| | activity | |
| | Change in pumping | None |
| | rates in water | |
| | wells in defined | |
| | localities | |
| | Change of water | None |
| | levels in defined | |
| | localities | |

OUTCOME—NO EARTHQUAKE OCCURRED

TABLE I-3

| | EVENT INPUT/ | |
|---|---|---|
| | EARTHQUAKE | |
| DATE & TIME | EVENT | EVENT DETAILS |
| | ULF peak | None |
| | Rise of temperature | None |
| | Chemical changes in | None |
| | water quality | |
| Mar. 31, 2009 | Change in animal | Slight |
| 18:32 | activity | |
| Apr. 2, 2009 | Change in pumping | Slight |
| 00:58 | rates in water | |
| | wells in defined | |
| | localities | |
| Apr. 2, 2009 | Change of water | A few cm |
| 04:21 | levels in defined | |
| | localities | |

OUTCOME—AN EARTHQUAKE OF A MAGNITUDE OF 3-4 ON THE RICHTER SCALE OCCURRED ON APR. 2, 2009 AT 06:01.

Future earthquake event prediction functionality 220 continuously matches combinations of sensed event inputs reported by data loggers 200 with learned earthquake event prediction patterns received from learned earthquake event prediction pattern generation functionality 230 to generate earthquake prediction report precursors, each indicating a future time to an expected earthquake event, with an indicated level certainty and an expected earthquake event magnitude, with an indicated level of certainty. Earthquake prediction reports are provided to various recipients based on predetermined thresholds, which are preferably based on a combination of future time to an expected earthquake event, with an indicated level certainty and an expect earthquake event magnitude, with an indicated level of certainty.

Thus, if a relatively high magnitude earthquake event is expected in a relatively short time, a report may be provided even if the level of certainty is relatively low and if a relatively low, but nevertheless significant, magnitude earthquake event is expected, the threshold level of certainty for issuance of a report may be significantly higher. Similarly, if a significant earthquake event is expected in a relatively long time, a report may not be provided if the level of certainty is relatively low.

Clearly different thresholds based on different combinations of warning time, magnitude and levels of certainty thereof may be appropriate to different recipients.

A few examples of the operation of the system and functionality of the present invention in various scenarios appear in Tables II-1, II-2 and II-3 below:

TABLE II-1

| | EVENT INPUT/ | EVENT | | PROBABILITY, | |
|---|---|---|---|---|---|
| | EARTHQUAKE | INPUT | | PREDICTED MAGNITUDE | |
| DATE & TIME | EVENT | DETAILS | ANALYSIS | AND TIME TO EARTHQUAKE | ACTION |
| Jan. 15, 2011 | ULF peak | 0.1 nanoTesla-5 | ULF peak is matched | Probability: 0-5%, | NO REPORT |
| 14:16 | | nanoTesla | with learned patterns | Magnitude: >5 on | SENT |
| | | (depending on the | which include ULF | Richter scale, with a | |
| | | distance from the | | certainty of 0-5%, | |
| | | epicenter) | | Time: 4-2 weeks | |
| Jan. 29, 2011 | Rise of | A dew | ULF peak and rise of | Probability: 0-5% | NO REPORT |
| 06:32 | temperature | degrees | temperature are | Magnitude: >5 on | SENT |
| | | Celsius | matched with learned | Richter scale, with a | |
| | | | patterns which include | certainty of 5-10% | |
| | | | ULF and temperature | Time: 4-1 days | |
| | | | levels. | | |
| Jan. 29, 2011 | Chemical | In excess of 10 | ULF peak, rise of | Probability: 0-5% | REPORT OF |
| 15:31 | changes in | parts per million | temperature and | Magnitude: >5 on | POSSIBILITY OF |
| | water quality | (Na+, Ca++, Mg++, | changes in ion | Richter scale, with a | EARTHQUAKE |
| | | SO₄−−, HCO₃−, F−, | concentration are | certainty of 20-30% | IS SENT TO |
| | | Cl−) | matched with learned | Time: 4 weeks-several | CIVIL DEFENSE |
| | | | patterns which include | days | AUTHORITIES |
| | | | ULF, temperature | | |
| | | | levels and Ion | | |
| | | | concentration. | | |
| Jan. 31, 2011 | Significant | Significant | ULF peak, rise of | Probability: 30-40% | INTERMEDIATE |
| 18:32 | change in | | temperature, changes | Magnitude: >5 on | PROBABILITY |
| | animal activity | | in ion concentration | Richter scale, with a | REPORT SENT |
| | | | and changes in animal | certainty of 50-60% | TO |
| | | | activity are matched | Time: 2 days-several | INDUSTRIAL |
| | | | with learned patterns | hours | CUSTOMERS |
| | | | which include ULF, | | AND CIVIL |
| | | | temperature levels, | | DEFENSE |
| | | | ion concentration and | | AUTHORITIES |
| | | | animal activity. | | |
| Feb. 2, 2011 | Significant | In excess of | ULF peak, rise of | Probability: 40-50% | HIGH |
| 00:58 | changes in | 10 m³/sec | temperature levels, | Magnitude: >5 on | PROBABILITY |
| | pumping rates | | changes in ion | Richter scale, with a | REPORT SENT |
| | in water wells | | concentration, changes | certainty of 70-80% | TO |
| | in defined | | in animal activity and | Time: 2 days-several | INDUSTRIAL |
| | localities | | changes in pumping | hours | CUSTOMERS |
| | | | rates are matched with | | AND CIVIL |
| | | | learned patterns which | | DEFENSE |
| | | | include ULF, | | AUTHORITIES |
| | | | temperature levels, ion | | |
| | | | concentration, animal | | |
| | | | activity and pumping | | |
| | | | rates. | | |
| Feb. 2, 2011 | Significant | Several meters | ULF peak, rise of | Probability: 60-70% | URGENT |
| 04:21 | changes of | | temperature levels, | Magnitude: >5 on | REPORT IS |
| | water level in | | changes in ion | Richter scale, with a | SENT TO ALL |
| | defined | | concentration, changes | certainty of 80-90% | RECIPIENTS |
| | localities | | in animal activity, | Time: A few hours-half | |
| | | | changes in pumping | an hour | |
| | | | rates and changes in | | |
| | | | water level are matched | | |
| | | | with learned patterns | | |
| | | | which include ULF, | | |
| | | | temperature levels, ion | | |
| | | | concentration, animal | | |
| | | | activity, pumping rates | | |
| | | | and water levels. | | |

PREDICTION—THERE IS AN 80%-90% CERTAINTY THAT AN EARTHQUAKE OF A MAGNITUDE IN EXCESS OF 6 ON THE RICHTER SCALE WILL OCCUR ON FEBRUARY 2 BETWEEN 4:51 AND 9:51.

TABLE II-2

| | EVENT INPUT/ | EVENT | | PROBABILITY, | |
|---|---|---|---|---|---|
| | EARTHQUAKE | INPUT | | PREDICTED MAGNITUDE | |
| DATE & TIME | EVENT | DETAILS | ANALYSIS | AND TIME TO EARTHQUAKE | ACTION |
| Jan. 15, 2011 | ULF peak | 0.1 nanoTesla-5 | ULF peak is matched | Probability: 0-5% | NO REPORT |
| 14:16 | | nanoTesla | with learned patterns | Magnitude: >5 on | SENT |
| | | (depending on the | which include ULF. | Richter scale, with a | |
| | | distance from the | | certainty of 0-5% | |
| | | epicenter) | | Time: 4-2 weeks | |
| Jan. 29, 2011 | Rise of | Slight | ULF peak and rise of | Probability: 0-5% | NO REPORT |
| 06:32 | temperature | | temperature are matched | Magnitude: >5 on | SENT |
| | | | with learned patterns | Richter scale, with a | |
| | | | which include ULF and | certainty of 5-10% | |
| | | | temperature levels. | Time: 4-1 days | |
| Jan. 29, 2011 | Chemical | Slight (Cl−) | ULF peak, rise of | Probability: 0-5% | REPORT OF |
| 15:31 | changes in | | temperature and changes | Magnitude: >5 on | POSSIBILITY OF |
| | water quality | | in ion concentration | Richter scale, with a | EARTHQUAKE |
| | | | are matched with learned | certainty of 20-30% | IS SENT TO |
| | | | patterns which include | Time: 4 weeks-several | CIVIL DEFENSE |
| | | | ULF, temperature levels | days | AUTHORITIES |
| | | | and ion concentration. | | |
| | Change in | None | ULF peak, rise of | Probability: 0-5% | NO |
| | animal activity | | temperature, changes in | Magnitude: >5 on | ADDITIONAL |
| | | | ion concentration and no | Richter scale, with a | REPORT SENT |
| | | | changes in animal | certainty of 10-15% | |
| | | | activity are matched | Time: 4 weeks-several | |
| | | | with learned patterns | days | |
| | | | which include ULF, | | |
| | | | temperature levels, ion | | |
| | | | concentration and animal | | |
| | | | activity. | | |
| | Changes in | None | ULF peak, rise of | Probability: 0-5% | NO |
| | pumping rates | | temperature, changes in | Magnitude: >5 on | ADDITIONAL |
| | in water wells | | ion concentration, no | Richter scale, with a | REPORT SENT |
| | in defined | | changes in animal | certainty of 0-5% | |
| | localities | | activity and no changes | Time: 4 weeks-several | |
| | | | in pumping rates are | days | |
| | | | matched with learned | | |
| | | | patterns which include | | |
| | | | ULF, temperature levels, | | |
| | | | ion concentration, | | |
| | | | animal activity and | | |
| | | | pumping rates. | | |
| Mar. 2, 2011 | Changes in | None | ULF peak, rise of | Probability: 0% | REPORT OF |
| 04:21 | water levels in | | temperature, changes in | | FALSE ALARM |
| | defined | | ion concentration, no | | IS SENT TO |
| | localities | | changes in animal | | CIVIL DEFENSE |
| | | | activity, no changes of | | AUTHORITIES |
| | | | pumping rates and no | | |
| | | | changes in water level | | |
| | | | are matched with learned | | |
| | | | patterns which include | | |
| | | | ULF, temperature levels, | | |
| | | | ion concentration, | | |
| | | | animal activity, pumping | | |
| | | | rates and water levels. | | |

PREDICTION—NO EARTHQUAKE WILL OCCUR

TABLE II-3

| | EVENT INPUT/ | EVENT | | PROBABILITY, | |
|---|---|---|---|---|---|
| | EARTHQUAKE | INPUT | | PREDICTED MAGNITUDE | |
| DATE & TIME | EVENT | DETAILS | ANALYSIS | AND TIME TO EARTHQUAKE | ACTION |
| | ULF peak | None | | Probability: 0% | NO REPORT |
| | | | | | SENT |
| | Rise of | None | | Probability: 0% | NO REPORT |
| | temperature | | | | SENT |
| | Chemical changes | None | | Probability: 0% | NO REPORT |
| | in water quality | | | | SENT |
| Jan. 31, 2011 | Changes in | Slight | No ULF peak, no rise of | Probability: 0-5% | NO REPORT |
| 18:32 | animal activity | | temperature levels, no | Magnitude: >3-4 on | SENT |
| | | | changes in ion | Richter scale, with a | |
| | | | concentration and slight | certainty of 20-30% | |
| | | | change in animal | Time: 2 days-several | |
| | | | activity are matched | hours | |
| | | | with learned patterns | | |
| | | | which include ULF, | | |
| | | | temperature levels, ion | | |
| | | | concentration and animal | | |
| | | | activity. | | |
| Feb. 2, 2011 | Changes in | Slight | No ULF peak, no rise of | Probability: 10-20% | REPORT OF |
| 00:58 | pumping rates | | temperature, no changes | Magnitude: >3-4 on | POSSIBILITY OF |
| | in water wells | | in ion concentration, | Richter scale, with a | LOW |
| | in defined | | slight changes in animal | certainty of 70-80% | MAGNITUDE |
| | localities | | activity and slight | Time: 2 days-several | EVENT IS SENT |
| | | | changes in pumping rates | hours | TO CIVIL |
| | | | are matched with learned | | AUTHORITIES |
| | | | patterns which include | | |
| | | | ULF, temperature levels, | | |
| | | | ion concentration, | | |
| | | | animal activity and | | |
| | | | pumping rates. | | |
| Feb. 2, 2011 | Changes of water | A few cm | No ULF peak, no rise of | Probability: 60-70% | HIGH |
| 04:21 | level in defined | | temperature, no changes | Magnitude: >3-4 on | PROBABILITY |
| | localities | | in ion concentration, | Richter scale, with a | REPORT FOR |
| | | | slight changes in animal | certainty of 70-80% | LOW |
| | | | activity, slight changes | Time: A few hours-half | MAGNITUDE |
| | | | of pumping rates and | an hour | EVENT IS SENT |
| | | | slight changes | | TO CIVIL |
| | | | (centimeters) in water | | AUTHORITIES |
| | | | levels are matched with | | |
| | | | learned patterns which | | |
| | | | include ULF, temperature | | |
| | | | levels, ion | | |
| | | | concentration, animal | | |
| | | | activity, pumping rates | | |
| | | | and water levels. | | |

PREDICTION—THERE IS A 70%-80% CERTAINTY THAT AN EARTHQUAKE OF A MAGNITUDE OF 3-4 ON THE RICHTER SCALE WILL OCCUR ON FEBRUARY 2 BETWEEN 4:51 AND 9:51.

Turning now to FIG. 3A, it is seen that each of the sensors continuously collects sample readings from its respective environment, which readings are stored in the data loggers. The data loggers preferably continuously calculate the average value of the last 100 sample readings. After filtering out sample readings which deviate more than 10% from the calculated average value, the data logger then recalculates and stores a new recalculated average value. The data logger then compares the new recalculated average to previously stored recalculated averages. If the new recalculated average deviates by more than 10% from any of the previously stored recalculated averages, the data logger sends an alert to server 108, where it is processed by future earthquake event prediction functionality 220 as described hereinabove regarding FIG. 2. In parallel, the rate of sampling of the sensors is increased.

Turning now to FIG. 3B, it is seen that upon receiving an alert regarding unusual sensor readings, future earthquake event prediction functionality 220 compares a combination of the events described in the alert and other recent events to event prediction patterns as generated by learned earthquake event prediction pattern generation functionality 230. Based on the comparison, future earthquake event prediction functionality 220 calculates the probability and time to a future expected earthquake event, as well as the probable magnitude of the future expected earthquake event.

It will be appreciated by persons skilled in the art that the present invention is not limited by what has been particularly shown and described hereinabove. Rather, the scope of the invention includes both combinations and subcombinations of various features described hereinabove as well as modifications and variations thereof which would occur to persons skilled in the art upon reading the foregoing and which are not in the prior art.

1. A system for predicting earthquakes comprising:
first sensing functionality for sensing at least one earthquake prediction parameter at least a first point in time prior to an expected earthquake event;
second sensing functionality for sensing at least one earthquake prediction parameter at least a second point in time prior to said expected earthquake event, said second point in time being different from said first point in time; and
prediction functionality operative in response to outputs from said first sensing functionality and from said second sensing functionality to provide a prediction of an expected earthquake event.

2. A system for predicting earthquakes according to claim 1 and also comprising:
third sensing functionality for sensing at least one earthquake prediction parameter at least a third point in time prior to said expected earthquake event, said third point in time being different from said first point in time and said second point in time and wherein
said prediction functionality is operative in response to outputs from said first sensing functionality, said second sensing functionality and said third sensing functionality to provide a prediction of an expected earthquake event.

3. A system for predicting earthquakes according to claim 2 and wherein each of said first, second and third sensing functionalities is operative to provide data outputs of said sensing to at least one data logger.

4. A system for predicting earthquakes according to claim 3 and wherein said at least one data logger provides data logger outputs to said system, said data logger outputs including periodic sensor values and respective associated time stamps, wherein said periodic sensor values differ from a steady state value by a predetermined deviation.

5. A system for predicting earthquakes according to claim 3 and wherein said system is operative to correlate data from the at least one data logger of each of said first, second and third sensing functionalities.

6. A system for predicting earthquakes according to claim 3 and wherein said system is operative to store said data logger outputs.

7. A system for predicting earthquakes according to claim 3 and wherein said system is operative to receive and store seismic data regarding actual earthquake events, said seismic data including at least one of a magnitude on the Richter scale and a time stamp.

8. A system for predicting earthquakes according to claim 2 and wherein said prediction functionality is operative in response to outputs from said first sensing functionality, from said second sensing functionality and from said third sensing functionality to match a combination of said outputs with learned earthquake event prediction patterns to provide a prediction of an expected earthquake event.

9. A system for predicting earthquakes according to claim 8 and wherein said learned earthquake event prediction patterns tie historical combinations of outputs from said first sensing functionality, from said second sensing functionality and from said third sensing functionality to historical earthquake events.

10. A system for predicting earthquakes according to claim 2 and wherein said prediction functionality employs an artificial neural network.

11. A system for predicting earthquakes according to claim 2 and wherein said prediction comprises a prediction of a future time to an expected earthquake event and a level of certainty associated therewith, and a prediction of an expected magnitude of said expected earthquake event and a level of certainty associated therewith.

12. A system for predicting earthquakes according to claim 2 and wherein said prediction functionality is operative to provide a report of said prediction to predetermined recipients.

13. A system for predicting earthquakes comprising:
first sensing functionality for sensing at least a first earthquake prediction parameter being in a first of physical, biological and hydrological parameter categories prior to an expected earthquake event;
second sensing functionality for sensing at least a second earthquake prediction parameter being in one of said physical biological and hydrological categories different from said first category prior to said expected earthquake event; and
prediction functionality operative in response to outputs from said first sensing functionality and from said second sensing functionality to provide a prediction of an expected earthquake event.

14. A system for predicting earthquakes according to claim 13 and also comprising:
third sensing functionality for sensing at least a third earthquake prediction parameter being in one of said physical, biological and hydrological categories different from said first category and said second category, prior to said expected earthquake event and wherein
said prediction functionality is operative in response to outputs from said first sensing functionality, from said second sensing functionality and from said third sensing functionality to provide a prediction of an expected earthquake event.

15. A system for predicting earthquakes according to claim 14 and wherein each of said first, second and third sensing functionalities is operative to provide data outputs of said sensing to at least one data logger.

16. A system for predicting earthquakes according to claim 15 and wherein said at least one data logger provides data logger outputs to said system, said data logger outputs including periodic sensor values and respective associated time stamps, wherein said periodic sensor values differ from a steady state value by a predetermined deviation.

17. A system for predicting earthquakes according to claim 15 and wherein said system is operative to correlate data from the at least one data logger of each of said first, second and third sensing functionalities.

18. A system for predicting earthquakes according to claim 15 and wherein said system is operative to store said data logger outputs.

19. A system for predicting earthquakes according to claim 15 and wherein said system is operative to receive and store seismic data regarding actual earthquake events, said seismic data including at least one of a magnitude on the Richter scale and a time stamp.

20. A system for predicting earthquakes according to claim 14 and wherein said physical category includes ULF related parameters.

21. A system for predicting earthquakes according to claim 14 and wherein said hydrological category includes parameters relating to levels of salinity, temperature, water, water turbidity, ion concentration, and the presence of nitrates, sulfates, radon and other gases.

22. A system for predicting earthquakes according to claim 14 and wherein said biological category includes parameters relating to levels of animal activity.

23. A system for predicting earthquakes according to claim 22 and wherein said levels of animal activity are sensed by at least one of at least one camera and at least one computer including suitable software.

24. A system for predicting earthquakes according to claim 14 and wherein said prediction functionality is operative in response to outputs from said first sensing functionality, from said second sensing functionality and from said third sensing functionality to match a combination of said outputs with learned earthquake event prediction patterns to provide a prediction of an expected earthquake event.

25. A system for predicting earthquakes according to claim 24 and wherein said learned earthquake event prediction patterns tie historical combinations of outputs from said first sensing functionality, from said second sensing functionality and from said third sensing functionality to historical earthquake events.

26. A system for predicting earthquakes according to claim 14 and wherein said prediction functionality employs an artificial neural network.

27. A system for predicting earthquakes according to claim 14 and wherein said prediction comprises a prediction of a future time to an expected earthquake event and a level of certainty associated therewith, and a prediction of an expected magnitude of said expected earthquake event and a level of certainty associated therewith.

28. A system for predicting earthquakes according to claim 14 and wherein said prediction functionality is operative to provide a report of said prediction to predetermined recipients.

29. A system for predicting earthquakes comprising:
first sensing functionality for sensing at least a first earthquake prediction parameter at least a first point in time prior to an expected earthquake event, said first earthquake prediction parameter being in a first of physical, biological and hydrological parameter categories;
second sensing functionality for sensing at least a second earthquake prediction parameter at least a second point in time prior to said expected earthquake event, said second point in time being different from said first point in time, said second earthquake prediction parameter being in one of said physical biological and hydrological categories different from said first category; and
prediction functionality operative in response to outputs from said first sensing functionality and from said second sensing functionality to provide a prediction of an expected earthquake event.

30. A system for predicting earthquakes according to claim 29 and also comprising:
third sensing functionality for sensing at least a third earthquake prediction parameter at least a third point in time prior to said expected earthquake event, said third point in time being different from said first point in time and said second point in time, said third earthquake prediction parameter being in one of said physical, biological and hydrological categories different from said first category and said second category and wherein
said prediction functionality is operative in response to outputs from said first sensing functionality, said second sensing functionality and said third sensing functionality to provide a prediction of an expected earthquake event.

31. A system for predicting earthquakes according to claim 30 and wherein each of said first, second and third sensing functionalities is operative to provide data outputs of said sensing to at least one data logger.

32. A system for predicting earthquakes according to claim 31 and wherein said at least one data logger provides data logger outputs to said system, said data logger outputs including periodic sensor values and respective associated time stamps, wherein said periodic sensor values differ from a steady state value by a predetermined deviation.

33. A system for predicting earthquakes according to claim 31 and wherein said system is operative to correlate data from the at least one data logger of each of said first, second and third sensing functionalities.

34. A system for predicting earthquakes according to claim 31 and wherein said system is operative to store said data logger outputs.

35. A system for predicting earthquakes according to claim 31 and wherein said system is operative to receive and store seismic data regarding actual earthquake events, said seismic data including at least one of a magnitude on the Richter scale and a time stamp.

36. A system for predicting earthquakes according to claim 30 and wherein said physical category includes ULF related parameters.

37. A system for predicting earthquakes according to claim 30 and wherein said hydrological category includes parameters relating to levels of salinity, temperature, water, water turbidity, ion concentration, and the presence of nitrates, sulfates, radon and other gases.

38. A system for predicting earthquakes according to claim 30 and wherein said biological category includes parameters relating to levels of animal activity.

39. A system for predicting earthquakes according to claim 38 and wherein said levels of animal activity are sensed by at least one of at least one camera and at least one computer including suitable software.

40. A system for predicting earthquakes according to claim 30 and wherein said prediction functionality is operative in response to outputs from said first sensing functionality, from said second sensing functionality and from said third sensing functionality to match a combination of said outputs with learned earthquake event prediction patterns to provide a prediction of an expected earthquake event.

41. A system for predicting earthquakes according to claim 40 and wherein said learned earthquake event prediction patterns tie historical combinations of outputs from said first sensing functionality, from said second sensing functionality and from said third sensing functionality to historical earthquake events.

42. A system for predicting earthquakes according to claim 30 and wherein said prediction functionality employs an artificial neural network.

43. A system for predicting earthquakes according to claim 30 and wherein said prediction comprises a prediction of a future time to an expected earthquake event and a level of certainty associated therewith, and a prediction of an expected magnitude of said expected earthquake event and a level of certainty associated therewith.

44. A system for predicting earthquakes according to claim 30 and wherein said prediction functionality is operative to provide a report of said prediction to predetermined recipients.

45. A method for predicting earthquakes comprising:
sensing at least a first earthquake prediction parameter at least a first point in time prior to an expected earthquake event;
sensing at least a second earthquake prediction parameter at least a second point in time prior to said expected earthquake event, said second point in time being different from said first point in time; and
in response to outputs from said sensing a first earthquake prediction parameter and from said sensing a second earthquake prediction parameter, providing a prediction of an expected earthquake event.

46. A method for predicting earthquakes according to claim 45 and also comprising:
sensing at least a third earthquake prediction parameter at least a third point in time prior to said expected earthquake event, said third point in time being different from said first point in time and said second point in time; and
in response to outputs from said sensing a first earthquake prediction parameter, from said sensing a second earthquake prediction parameter and from said sensing a third earthquake prediction parameter, providing a prediction of an expected earthquake event.

47. A method for predicting earthquakes comprising:
sensing at least a first earthquake prediction parameter being in a first of physical, biological and hydrological parameter categories prior to an expected earthquake event;
sensing at least a second earthquake prediction parameter being in one of said physical biological and hydrological categories different from said first category prior to said expected earthquake event; and
in response to outputs from said sensing a first earthquake prediction parameter and from said sensing a second earthquake prediction parameter, providing a prediction of an expected earthquake event.

48. A method for predicting earthquakes according to claim 47 and also comprising:
sensing at least a third earthquake prediction parameter being in one of said physical, biological and hydrological categories different from said first category and said second category, prior to said expected earthquake event and wherein
in response to outputs from said sensing a first earthquake prediction parameter, from said sensing a second earthquake prediction parameter and from said sensing a third earthquake prediction parameter, providing a prediction of an expected earthquake event.

49. A method for predicting earthquakes comprising:
sensing at least a first earthquake prediction parameter at least a first point in time prior to an expected earthquake event, said first earthquake prediction parameter being in a first of physical, biological and hydrological parameter categories;
sensing at least a second earthquake prediction parameter at least a second point in time prior to said expected earthquake event, said second point in time being different from said first point in time, said second earthquake prediction parameter being in one of said physical biological and hydrological categories different from said first category; and
in response to outputs from said sensing a first earthquake prediction parameter and from said sensing a second earthquake prediction parameter, providing a prediction of an expected earthquake event.

50. A method for predicting earthquakes according to claim 49 and also comprising:
sensing at least a third earthquake prediction parameter at least a third point in time prior to said expected earthquake event, said third point in time being different from said first point in time and said second point in time, said third earthquake prediction parameter being in one of said physical, biological and hydrological categories different from said first category and said second category and wherein
in response to outputs from said sensing a first earthquake prediction parameter, from said sensing a second earthquake prediction parameter and from said sensing a third earthquake prediction parameter, providing a prediction of an expected earthquake event.
